(19) United States
(12) Patent Application Publication
(10) Pub. No.: US 2003/0010091 A1
(43) Pub. Date: Jan. 16, 2003

(54) System and method for detecting occlusions in a semiconductor manufacturing device

(76) Inventor: Bradley Dale Mitchell, McKinney Texas, TX (US)

Correspondence Address: William N. Hulsey III, Hughes & Luce, L.L.P., Suite 2800, 1717 Main Street, Dallas, TX, 75201, US

(21) Appl. No.: 09/903,119

(22) Filed: Jul. 10, 2001

(51) Int. Cl. G01M 3/02

(52) U.S. Cl. 73/37; 438/5; 438/14

(57) ABSTRACT

The present invention is directed to an apparatus and method for detecting blockage for a semiconductor fabrication system. The detector is made of a flow detector, interposed in a gaseous flow path between a gas supply and the rest of the system. A flow comparator is coupled to the flow detector, and compares the flow rate of the gas to a baseline flow rate of gas. In this manner, blockages of the system can be detected before a catastrophic failure. In one embodiment, the flow detector is a heating element coupled to a power supply. The heating element heats the gas flowing past it, thus determining the volume or flow of gas. A temperature-measuring device is coupled to the heating element, and the heating element can be selectively enabled in response to a signal from the temperature-measuring device. A power measurement device measures the power used by the heating element. Thus, the duty cycle of the heating element indicates the flow rate of the gas. A control circuitry is communicatively coupled to the flow detector. The control circuitry is responsive to a measured parameters related to the rate of flow of the gas to the chamber. The system may issue an alarm, update a maintenance schedule, or change the operation of the system in response to a varied number of warning levels.

### FIELD OF THE INVENTION

The present invention relates detecting occlusions in a semiconductor fabrication chamber assembly. In particular the invention relates to a system and method for detecting and reacting to occlusions, and for maintaining a cleaner semiconductor fabrication chamber.

### BACKGROUND OF THE INVENTION

In the typical existing semiconductor fabrication chambers, the environment of the chamber produces a sheeting layer of material on the walls of the chamber, and in the inlets and outlets to such chambers. This is due to the reaction atmosphere inside the chamber. In the course of semiconductor fabrication operations, the sheeting approaches levels that restricts or does not allow at all for the passage of gas through the chamber vessel and related intakes and outtake systems. When this occurs, the chamber must be opened and cleaned. This process is known as a “wet clean.”

In a typical production process, which operates at sub-atmospheric conditions, some sort of vacuum source needs to be employed. This vacuum system is usually connected to a process chamber where the production is being performed.

In the production of semiconductor wafers, these process chambers are used for the manufacture of integrated circuit structures on semiconductor wafers. This can take the form of deposition of thin films, plasma dry etch, and other applications. Each of the various applications produces excess chemistries or residual byproducts. These residual byproducts are typically removed from the process chamber via the vacuum pump and connecting vacuum lines.

As these unused or unwanted materials travel through the vacuum lines, they often deposit on the inner walls of the vacuum lines, or other parts of the process flow modules. As this deposited material builds up, a restriction can form and the effectiveness of the vacuum system degrades. This degradation continues until the process chamber can no longer meet the qualification specifications that are required for production.

At the very low gas flow rates used for production, the detection of the growing restriction goes undetected until the chamber must be removed form production. This can happen with very little warning.

In many typical systems, the determination of when to clean the systems is nothing more than educated guesswork. Schedules are maintained, based upon the reaction chemistries and length of processes in the chambers.

The cleaning of the chambers and associated piping is an arduous task. The sheeting must be taken off the sides, and the piping and chamber walls must be cleaned thoroughly before reinitiating the semiconductor fabrication process. This cleaning process can take a large amount of time. Additionally, to reinitialize the process chamber may take additional time, since any atmospheric borne molecules must be drawn out of the chamber walls.

Thus, the timing of the cleanings, when improperly timed, results in excessive downtime for the system. If a chamber is cleaned before the necessary time, then there is substantial shortfall in the fabrication time associated with this.

Further, when there is some catastrophic failure, such as an early occlusion of the chamber or the piping, this could severely damage the manufacturing instruments. Additionally the materials being processed stand a great chance of being damaged in this failure. This problem dictates that a cleaning schedule be determined with a conservative estimate of time between cleanings. However, the conservative time between cleaning dictates a great deal of downtime for the system.

Further, the time and effort to clean the chamber and process flow walls may be extensive. Further, at times the deposited material may not be sufficient to justify the cleaning process, since time and effort must also be spent in de-adsorbing molecules from the wall of the chamber and process flow modules. The opening of the chamber to clean it introduces various environmental agents to the walls of the process flow modules and the reaction chamber. As such, a disadvantage with a full clean of the system is also found in the time to reseal the chamber and deadsorb molecules from the chamber and process flow module walls.

In this manner, the typical prior art does not allow for flexible processing schedules as well as the early detection of occlusive events in such a system. Nor do the typical prior art systems allow for the active reduction of deposited residual materials on the walls of the chamber, or the associated process flow structures without opening the system to an external atmosphere. In this manner, the typical prior art cannot dynamically adapt and proactively attempt to reduce the occlusive effects of buildup in chamber walls. Many other problems and disadvantages of the prior art will become apparent to one skilled in the art after comparing such prior art with the present invention as described herein.

### SUMMARY OF THE INVENTION

Aspects of the invention are found in a system for buildup detection in a semiconductor manufacturing system. This system produces integrated circuit structures on semiconductor wafers. The system has a chamber for placing the semiconductor wafers, and the chamber is environmentally coupled to a gas source through a gaseous flow path.

The detector is made of a flow detector, interposed in the gaseous flow path that determines a flow rate of gas flowing from the gas supply to the rest of the system. A flow comparator is coupled to the flow detector. The flow comparator compares the detected flow rate of the gas to a baseline flow rate of gas.

In another aspect of the invention the flow detector is a heating element coupled to a power supply, and the heating element heats the gas flowing past it. In this manner, the volume or flow of gas can be determined through thermal measurement. A temperature-measuring device is coupled to the heating element, and the heating element can be selectively enabled in response to a signal from the temperature-measuring device.

In another aspect of the invention, a power measurement device measures the power that goes to the heating element. Thus, the duty cycle of the heating element indicates the flow rate of the gas.

In another aspect of the invention the detector has a flow controller. This flow controller is communicatively coupled to the gas supply and controls the flow of gas to the chamber in response to a signal from the flow detector. The invention may contain a control circuitry communicatively coupled to the flow detector. The control circuitry is responsive to a predetermined value related to the rate of flow of the gas to the chamber. The control circuitry may be programmable. This may be used to issue an alarm in response to the detection of the predetermined value, or to update a maintenance schedule in response to the detection of a predetermined value. The control circuitry can change the operational status of the system in response to the detection of a predetermined value as well.

Such predetermined values may be those values associated with the gas flow, such as a flow rate. Or other values may be used, such as is a rate of change in the flow rate, or other time-based derivatives thereof.

A second flow detector may also be used in conjunction with the first. In this manner, a location, as well as existence, of an occlusion can be determined.

Other aspects of the invention can be found in a system that produces integrated circuit structures on semiconductor wafers. The system contains many of the same features as described above.

Another aspect of the invention may be found in a method of detecting residue buildup in an apparatus for manufacturing integrated circuit structures on a semiconductor wafer. The method has the steps of causing to flow through the apparatus a gas; determining a volume of gas flowing from the gas supply; and comparing the flow of the gas to a baseline flow of gas.

In one aspect, the step of determining is made up of heating the gas with an element coupled to a power supply and then measuring the power consumed by the element. Additionally, the steps of measuring the temperature of the gas and selectively enabling the element enabled in response to step of the measuring the temperature may be used.

The system can change the flow of the gas supply to the chamber in response to a signal from the flow detector. Additionally, the system may detect a predetermined value, and, in response, selectively initiating an action in response to the detection.

Such an action could include issuing an alarm in response to the detection of a predetermined value. Or, the action may be one of updating a maintenance schedule in response to the detection of a predetermined value.

As such, a dynamic, updateable occlusion detection system for semiconductor fabrication chambers is envisioned. Other aspects, advantages and novel features of the present invention will become apparent from the detailed description of the invention when considered in conjunction with the accompanying drawings.

### DESCRIPTION OF THE DRAWINGS

FIG. 1 is a schematic block diagram of an occlusion detection system according to the invention.

FIG. 2 is an exemplary embodiment of flow metering system as depicted in FIG. 1.

FIG. 3 is a schematic block diagram of an implementation of the system of FIG. 1 across multiple semiconductor manufacturing systems.

FIG. 4 is a flow diagram detailing an exemplary process by which the semiconductor manufacturing system of FIGS. 1 or 2 may operate.

FIG. 5 is a flow diagram detailing an exemplary process by which the semiconductor manufacturing system of FIG. 3 may operate.

FIG. 6 is a flow diagram showing an exemplary method by which the system of FIG. 1 or FIG. 2 may operate.

FIG. 7 is a cross section view of a portion of the process flow, detailing an aspect of the invention.

FIG. 8 is a method that may employed by the system of FIG. 1 to alleviate deposit material in the semiconductor manufacturing system.

FIG. 9 is an alternative embodiment of the method of FIG. 7.

### DETAILED DESCRIPTION

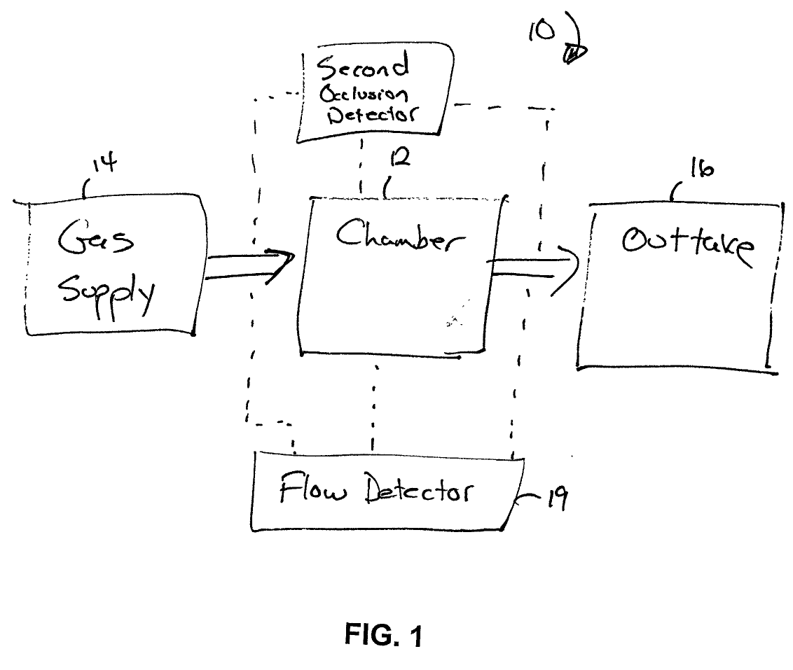

FIG. 1 is a schematic block diagram of an occlusion detection system according to the invention. A semiconductor manufacturing system 10 contains a semiconductor-manufacturing chamber 12. The chamber contains semiconductor wafers that are processed, typically at near-vacuum pressures. The process may take place at various temperatures. Typically, the environment where the wafer is can be at a high temperature to facilitate physical and chemical processes occurring to the wafer.

The system also contains a gas source 14 and a gas outlet 16, both coupled to the chamber 12. In this manner, gases may be cycled from the gas source 14 to the gas outlet 16 through the chamber 12.

The flow of gas through the system is controlled by a flow controller. In this manner, the amount of gas flowing through the reaction chamber may be closely controlled.

A flow detection unit 19 monitors the flow of gas from the gas supply to the chamber and the associated downstream process flow modules. As such, a difference in the flow rates of the fabrication system 10 indicate an occlusion in the system. Typically, the flow testing will take place at pressures higher than those used for fabrication processes. The higher volumes and flow rates can indicate a problem well in advance as opposed to the lower pressures found in the production systems. The system can be used in production type operations, but its effectiveness is increased with higher pressures than typically found in production.

A flow-testing schedule may be implemented on a widely varying basis. In one embodiment, the flow test is performed at a higher pressure for approximately eight minutes on daily basis. However, a schedule of testing can implement longer or shorter testing periods, and on a different temporal schedule, such as a bi-daily, biweekly, or any other temporal basis imaginable.

Additionally, the temporal type schedule may be replaced with a usage-based schedule. In this case, the system would be flow tested every nth fabrication process.

The flow metering may be accomplished several different ways. A ball suspension flow meter may be employed, a rotary flow meter may be employed, or a diaphragm pressure differential type flow meter may be employed.

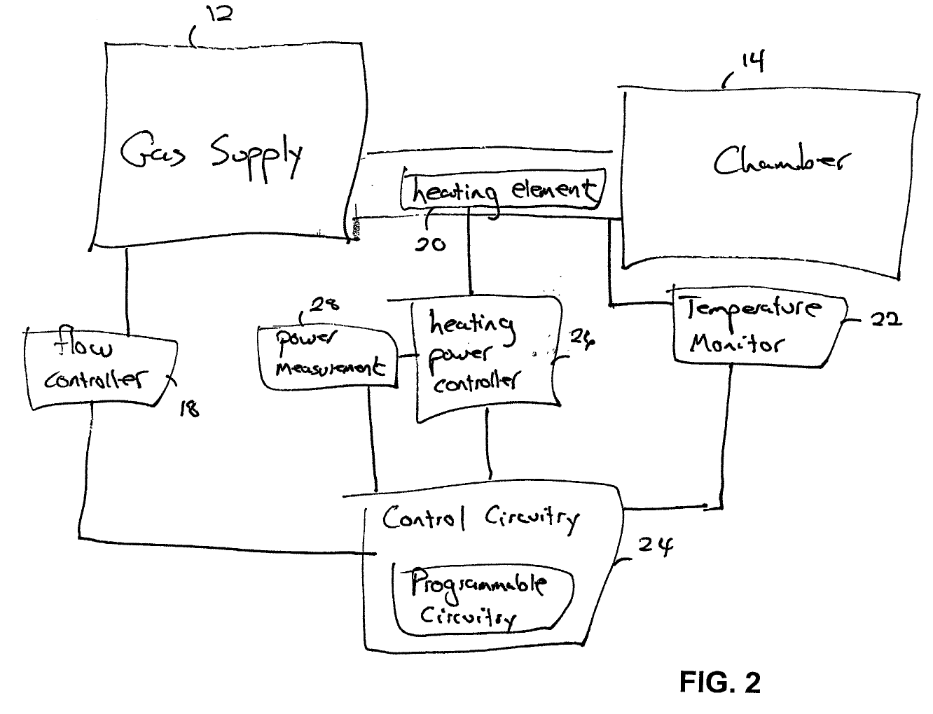

FIG. 2 is an exemplary embodiment of flow metering system as depicted in FIG. 1. In this particular embodiment, the flow meter contains a heating element 20 interposed between the gas supply 14 and the chamber. The heating element 20 can be used to heat the gas supply to provide an optimal temperature in the reaction chamber for the semiconductor fabrication process.

A temperature measurement device 22 monitors the temperature of the gas flowing from the gas supply 14 to the reaction chamber 12 after it has been heated by the heating element 20. The temperature may be monitored by various means, including a thermocouple. In this manner, a heated gas may be swept through the reaction chamber 12. In a reaction process for semiconductor materials, the gas can be an inert gas, such as argon, or a reactive gas. In terms of the flow metering, any gas conducive to the internal environment of the reaction chamber or other process flow module may be used.

The heating element 20 is typically a reactive-type heating element, requiring electric power to maintain a temperature. As such, the heating element 20 is coupled to a heating power controller 26. The heating power controller 26 maintains power to the heating element 20, thus allowing the heating element 20 to heat the gas flowing to the reaction chamber 12.

A power measurement device 28 monitors the power flow in to the heating power controller 26. The power management device 28 measures the amount of heating that the heating element 20 performs on the gas flowing to the reaction chamber 12.

Both the temperature measurement device 22 and the power management device 28 are coupled to coupled to a control circuitry 24. The control circuitry 24 monitors the status of the temperature, the power used, or both. Thus, the control circuitry 24 can monitor the entire state of the gas flow, heating state of the semiconductor manufacturing system 10.

The control circuitry 24 is coupled to a flow controller 18, and/or the heating power controller 26. In this manner, the amount of gas flowing into the system and/or the temperature of the gas may be monitored and determined.

In an exemplary embodiment, the semiconductor manufacturing system 10 is operating at a certain state. The gas is flowing at a determined rate and at a determined temperature to the reaction chamber 12. As the gas flows across the heating element 20, the gas is heated according to the amount of power released by the heating element 20. Should the temperature-measuring device 22 determine that the temperature is below a certain threshold, it may indicate this to the control circuitry 24. In turn, the control circuitry 24 initiates the heating power controller 26 to a longer duty cycle. The duty cycle of the heating power controller is monitored by the power management device 28, and the results of this measurement are sent back to the control circuitry 24.

The heat of the gas at the temperature-measuring device 22 is proportional to the heat transferred to the gas by the heating power controller 26. The heat transferred to the gas by heating power controller 26 is related to the volume of gas flowing to the reaction chamber 12. Thus, the heat of the gas as determined by the temperature measuring device 22 is related to the volume of gas flowing to the reaction chamber 12.

Further, the heat transferred to the gas is related to the duty cycle of the heating power controller 26. In this manner, the volume of gas flowing can be determined by the results of the power management device 28.

If an occlusion occurs, then the ability of the semiconductor manufacturing system 10 to vent gas from the outtake 16 is diminished. This means that the volume of heated gas flowing through the system is diminished, and that the amount of heat that must be added to the system is also diminished. When the duty cycle of the heater is correspondingly diminished, this indicates a buildup of substance somewhere in the semiconductor manufacturing system 10.

The control circuitry 24 monitors the duty cycle of the heating power controller through the power management device 28. The duty cycle is indicative of the buildup of substance in the system. When the duty cycle decreases, this is indicative of more buildup of material than before.

The control circuitry 24 not only monitors the duty cycle, but also monitors the rate at which the duty cycle changes. Thus, the control circuitry 24 can predict when a system will be ready for maintenance based on the direct measurement of power used by the heating power controller 26. Alternatively, when the rate of change varies abruptly, the control circuitry 24 may issue several types of warnings and actions, including shutting the system down. In the case when the flows are monitored during production, this would tend to avoid a catastrophic failure as featured above.

However, the system is preferably used in an environment with higher than production-type pressures, and as such, a warning to clean the system prior to next use may be preferable. In this case, a shutout mechanism may be employed with the fabrication system. When a predetermined criteria is met, or a sudden change occurs, the system may generate an electronic shut out. This would disable operations in the particular semiconductor manufacturing system until acceptable levels are reached.

Alternatively, the control circuitry 24 may change the output of the gas through interacting with the flow controller 18 in an attempt to salvage the process in place. Thus, the system can interactively alter the process flow to facilitate both completion of the existing process without damage to the system or the resulting semiconductor device.

The exemplary embodiment contains many advantages. First, in many semiconductor-manufacturing systems, it is necessary to heat the gas flow. Thus, existing reactive heaters may be retrofitted to perform this measurement task. Secondly, the addition of the heating element to new systems is not an added burden to the existing parameters necessary for the system to work. Thirdly, abrupt changes may be detected and acted upon far in advance of a situation that would cause severe problems to the manufactured semiconductor or the system itself.

In one embodiment, a similar or different flow detection device may be coupled at another part of the semiconductor manufacturing system 10. By comparing flow rates or pressures, specific locations of occlusions or types of occlusions may be identified.

It should be noted that the power measurement device 28 might be directly coupled to the heating power controller 26 or the flow controller 18 for purposes of this discussion. Additionally, it should be noted that the temperature monitor 22 might be similarly coupled to the heating power controller 26 and/or the flow controller 18 as well. In this case, the power measurement device 28 or the temperature measurement device 22 can directly control the heating power controller 26 and/or the flow controller 18 based on the state of the measurement(s).

It should also be noted that the temperature measurement device 22 need not be in direct line with the heating element 20. In fact, such a temperature measurement device 22 may be placed anywhere downstream from the heating element 20.

It should also be noted that components of the control circuitry 24 need not exist as a separate unit. The functionalities of the control circuitry 24 can be distributed across the various components described above to function in a similar manner. Additionally, it should be noted that the connections between the functional blocks need not be of any particular type. They may be hardwired connections between computer components, or networked across many computing devices. Alternatively, the connections may take the form of wireless connections. These devices may include general computers, smart card enabled devices, handheld computing devices, or network appliance type devices.

The process may be run using baselines based on production cycles. Alternatively, the baselines may be based on wet clean cycles between the process cycles. In the wet clean cycle, the volume of gas may be increased beyond that usually found in the production cycle, and, due to the higher volume, more precise measurements of occlusive buildup and their rates may be determined.

Additionally, the control circuitry may be programmable. This allows the implementation of a wide ranging alert and control system that reacts specifically to different situations.

In the application of the invention, an industrial gas heater voltage usually remains constant, such as 120 volts alternating current (VAC), 208 VAC, or 240 VAC as is supplied from a power source. Since these voltages are very consistent, another way to control the element temperature can be provided. In one embodiment, the system controls the duty cycle of the element in the “On,” or heating, state. This controls the amount of energy being delivered to the resistance element. This energy management procedure can very precisely control the heat output from the element. In the present system, the user calibrates the various duty cycles against different known gas flow volumes. With this calibration, the amount of gas being heated in our system may be determined, and thus the system can report this volume as needed.

With the use of our use of heated gas flowing at greater volumes than that of production process gas flows, one is able to detect the growing restriction well in advance of their becoming a problem. First, a baseline is established on a known system that has been cleaned or purged, or otherwise known to be free of such restrictions. A high flow gas from the gas heating system is periodically blown through the process chamber and through the vacuum system, and one can compare the relative gas flows. Any reduction in gas flow due to degradation in the pumping system efficiency can be detected and reported. This condition can be detected much earlier using the high flow gas condition. As such, required maintenance can be scheduled in order to minimize the impact on production.

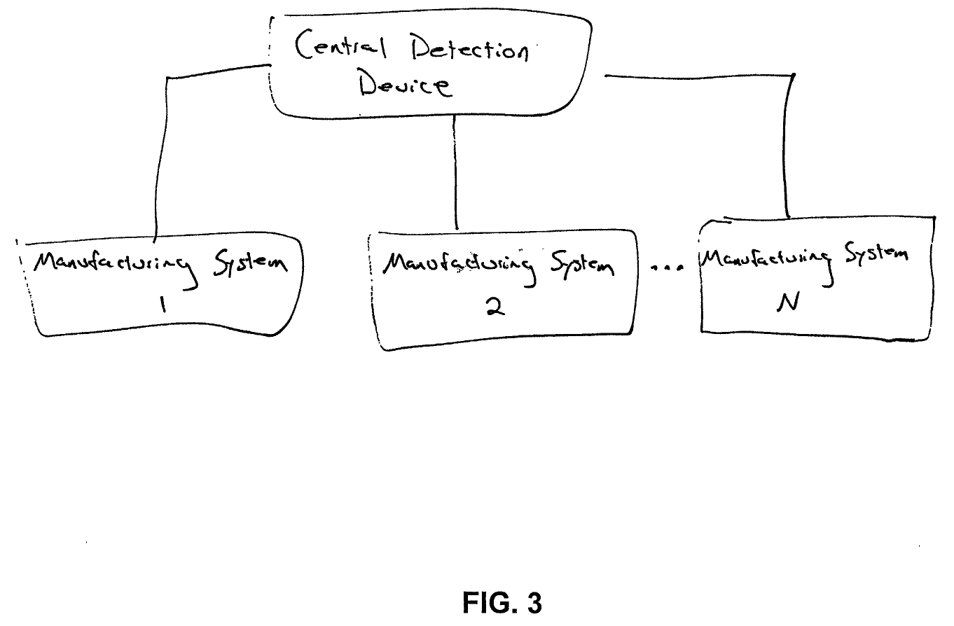

FIG. 3 is a schematic block diagram of an implementation of the system of FIG. 1 across multiple semiconductor manufacturing systems. In this diagram, the control circuitry or computing device monitors and affects multiple semiconductors manufacturing systems. Thus, a centralized process server may be realized. In this manner, the control circuitry or computing device can determine maintenance schedules for multiple semiconductor manufacturing systems concurrently. Additionally, the control circuitry or computing device may affect an alert system for the multiple semiconductor manufacturing systems.

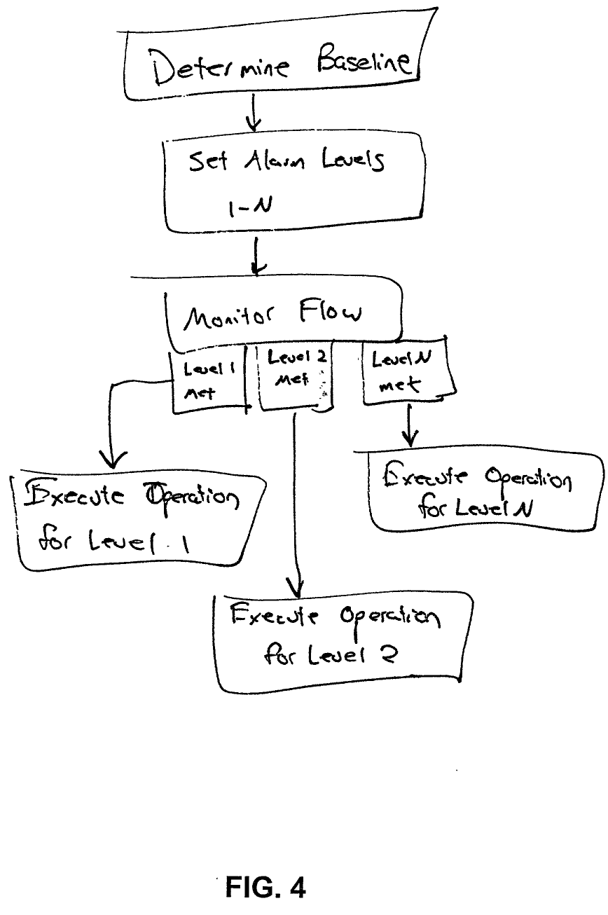

FIG. 4 is a flow diagram detailing an exemplary process by which the semiconductor manufacturing system of FIGS. 1 or 2 may operate. In this case, the system is programmed to respond to differing events in differing manners. These differing events are gleaned from the flow information, such as amount of occlusion, rate of buildup of occlusion, or change in the rate of buildup. Differing alarm levels may be defined for differing events or indicia. In response, events can be defined for the differing indicia, based upon the type or seriousness of the event.

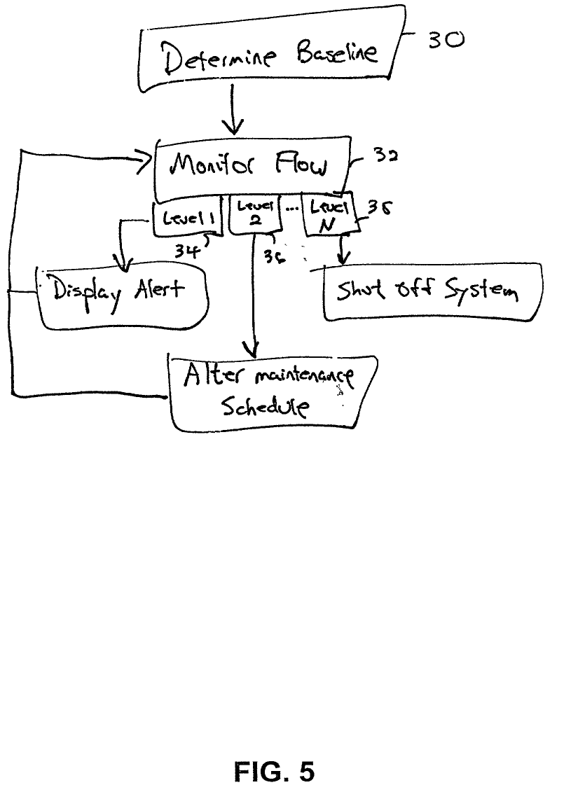

FIG. 5 is a flow diagram detailing an exemplary process by which the semiconductor manufacturing system of FIG. 3 may operate. In a block 30, a baseline is determined for the semiconductor manufacturing system. In a block 32, the monitoring system monitors gas flow characteristics in the semiconductor manufacturing system. The characteristics may include the gas flow level, the rate of change (“velocity”) of the gas flow level, or the rate of change of the rate of change (“acceleration”) of the gas flow level. Based on the levels of these characteristics, various levels of alerts or automatic functional steps can be defined.

In this embodiment, when a monitor alarm level 1 occurs, depicted in a block 34, a specific alert is displayed. Of course, this alert may also be in the form of an electronic communication to an individual, perhaps by such means as an instant messaging service or e-mail. Alternatively, the electronic message may be sent to a database with the characteristics, which mat tie into a separate maintenance scheduler.

When the characteristics initiate an alarm level 2, as depicted in a block 36, the system may simply alter the flow/temperature characteristics to accommodate other parameters. These parameters may include time to finish a process, expected time to maximum occlusion, time to maintenance, or altering the thermal characteristics to effectuate a change in the system itself, as will be explained in a later section.

When the characteristics initiate an alarm level 3, as depicted in a block 38, the system may shut the system down. This would occur when the safety of the system is implicated, or when the processes may no longer be effectuated absent some corrective action.

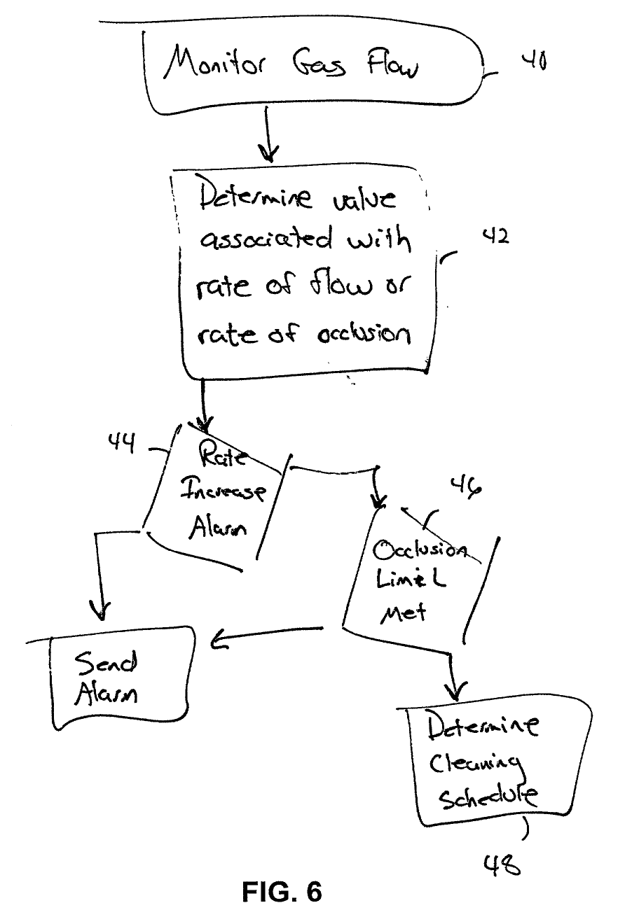

FIG. 6 is a flow diagram showing an exemplary method by which the systems of FIGS. 1, 2, or 3 may be operated. In a block 40, the system monitors the state of the system thorough the gas flow. In a block 42, the rate of buildup or the present amount of buildup is calculated based on the flow parameters or the rate of change of the flow parameters.

In a block 44, the rate of occlusion is tested. If the rate of occlusion has a sudden change, then some significant event has happened. This may indicate a sudden buildup in a particular segment, the drift of a large amount of material to a small juncture, or the breaking off of occlusive material. If such a rate change is detected, then a notice or alarm is generated as appropriate. Alternatively, a preventative act may take place, such as the termination of the process.

In a block 46, the amount of occlusion is determined. If the amount has reached a critical level, an alarm may be generated, or, in other situations, a preventative act may take place.

In a block 48, a maintenance time is scheduled based on the rate of occlusion, the amount of occlusion, both, or other parameters that may be derived from the system. In this manner, an efficient maintenance schedule may be implemented with minimal amount of downtime.

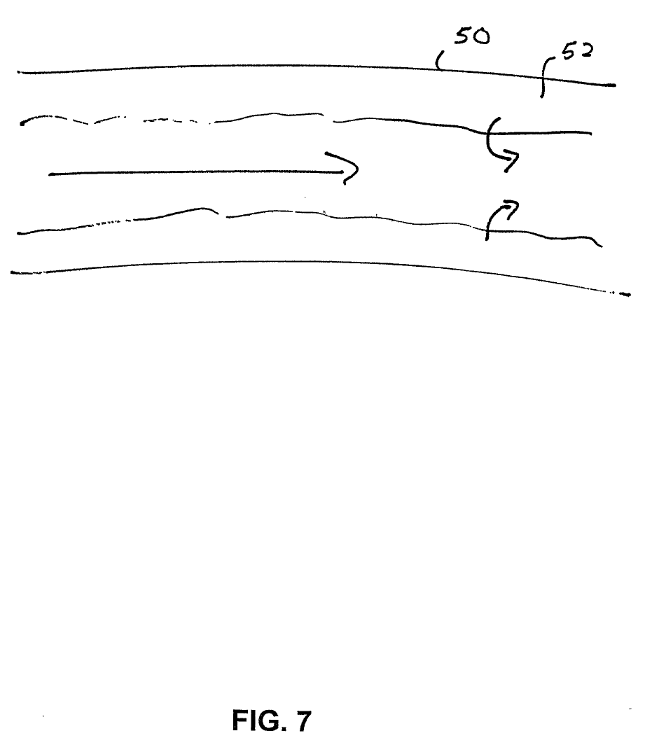

FIG. 7 is a cross section view of a portion of the process flow, detailing an aspect of the invention. In the semiconductor manufacturing process, the environment of the process leads to the deposit of material on the walls of the reaction chamber and on the process flow unit walls. In the FIG. 6, a typical process module wall 50 has material 52 deposited on it. In the process flow, gas flows in the volume bounded by the deposit material 52. As the deposit material 52 increases, the airflow thus decreases as well, as has been explained earlier.

In an aspect of the invention, the deposit material is heated by the gas. Between production cycles, a high volume cycle may take place as described above, where larger volumes of heated gas are made to flow through the process flow. The heat contained in the gas places the environmental conditions in the reaction flow to a point that sublimation, or the process where solids transform directly to gas, may occur. As such, the molecules of the deposit material sublimate into the flow stream and are carried out of the process cycle. Thus, the gas flow provides both the thermal energy for the sublimation, and the kinetic energy to carry the sublimated material out of the chamber. Thus, the intrinsic measurement mechanism may be used as an alleviation mechanism as well. In this case, any gas can be used, as described above. In cases where the reaction chemistries can tolerate a reactive gas, a reactive gas can be used to enhance the sublimation process.

An alleviation cycle can be maintained, as described above in relation to the occlusion detection. The cycle can be driven by temporal schedules, usage schedules, or can be driven by the above described flow rate determination. When the alleviation process is used, this tends to lengthen the time between wet cleans dramatically.

However, the alleviation process typically should not take place during semiconductor processing. This is due to the affect that the sublimation process may directly affect product being worked upon.

It should be noted that these conditions might exist in production cycles as well. Thus, the system may actually self-clean through sublimation while measuring the problems. In one embodiment, a first run may determine the amount of deposit in the process flow. Then, based on the amount of deposit, the rate of change of deposit, or on the change in the rate of change of deposit, the thermal, temporal, or volumetric properties of the heating/flow gas mechanism may be altered to “clean up” certain amounts of deposit material prior to the next production cycle. In this manner, the deposit material in process flow may be alleviated without cracking the system open to an external environment.

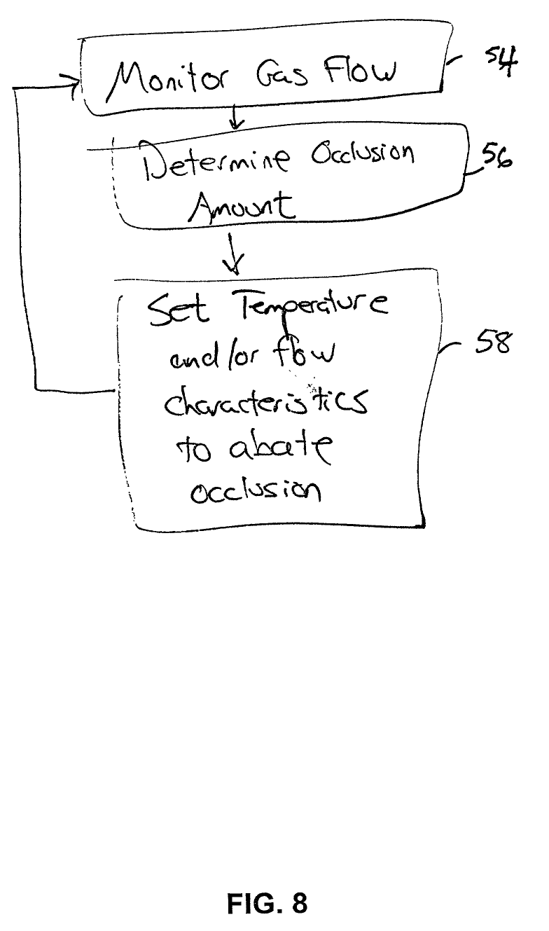

FIG. 8 is a method that may employed by the system of FIG. 1 to alleviate deposit material in the semiconductor manufacturing system. In a block 54, a preliminary gas flow measurement is taken. In a block 56, the system determines the parameters of the deposit material. This includes the amount of deposit material, the rate at which the deposit material is building up, and the change of the rate at which the deposit material is building up. Based on these parameters, the thermal and flow characteristics of a closed seal maintenance cycle are chosen in a block 58, such that portions of deposited material will be sublimated out of the process flow. The process may repeat itself, or it may end, as desired.

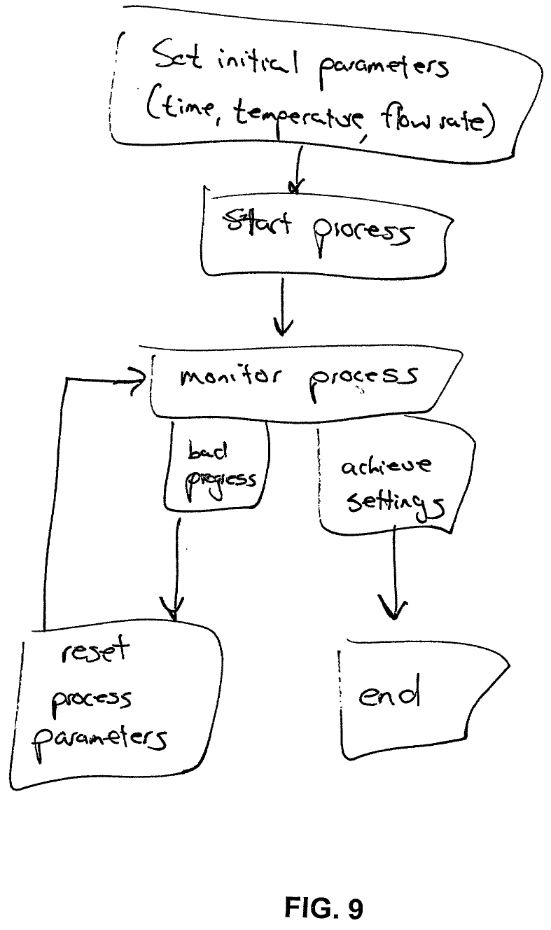

FIG. 9 is an alternative embodiment of the method of FIG. 8. A sublimation process is initiated. The initial thermal/flow characteristics are set in a block 62. The process is monitored in a block 64. Based upon the measured parameters in a block 64, the thermal characteristics may be dynamically altered in the process in a block 66. Upon achieving a certain predetermined setting in a block 68, the process may self-end.

It should be noted that the processes described above take place after the maintenance cycle that introduces an external environment into the inner structures of the process flow modules and the reaction chamber, and after these structures have had a deadsorption process run on them. This saves time and energy, since external molecules that may adsorb into the chamber and process flow structures are not introduced into the system. This saves time and energy in repeated maintenance cycles exposed to the external environment and in time and effort for the resulting deadsorption process necessary after the process flow modules are resealed from the external environment. In this manner, the process may be run repeatedly before a cleaning or maintenance operation that opens it to the external environment is necessary.

Thus, architecture for implementing a semiconductor process monitoring system is described. It should be noted that such elements of an architecture might be implemented with a computing device. The computing device may be a general purpose or specialized computing device. It should also be noted that the portions of the architecture may be implemented as software run on the computing device and within such components as magnetic media or computer memory associated with the computing device, or as hardware, operating alone or in conjunction with such software.

In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

What is claimed is:

1. A blockage detector for a system that produces integrated circuit structures on semiconductor wafers, the system having a chamber for placing the semiconductor wafers, the chamber environmentally coupled to a gas source through a gaseous flow path, the detector comprising:
a flow detector, interposed in the gaseous flow path, that determines a flow rate of gas flowing from the gas supply; and
a flow comparator, communicatively coupled to the flow detector, that compares the detected flow rate of the gas to a baseline flow rate of gas, a decrease in the flow rate of the gas indicative of a blockage in the gaseous flow path.

2. The detector of claim 1 wherein the flow detector is a heating element coupled to a power supply, the heating element heating the gas flowing past it.

3. The detector of claim 2 further comprising:
a temperature measuring device, communicatively coupled to the heating element; and
the heating element is enabled in response to a signal from the temperature measuring device.

4. The detector of claim 2 further comprising:
a power measurement device, coupled to the heating element, that measures the amount of power directed to the heating element.

5. The detector of claim 1, further comprising:
a flow controller, communicatively coupled to the gas supply, that controls the flow of gas to the chamber; and
the flow controller changing the flow of the gas supply to the chamber in response to a signal from the flow detector.

6. The detector of claim 1, further comprising:
a control circuitry communicatively coupled to the flow detector, the control circuitry responsive to a predetermined value related to the rate of flow of the gas to the chamber.

7. The detector of claim 6, wherein the control circuitry is programmable.

8. The detector of claim 6, the control circuitry issuing an alarm in response to the detection of a predetermined value.

9. The detector of claim 6, the control circuitry updating a maintenance schedule in response to the detection of a predetermined value.

10. The detector of claim 6, the control circuitry changing the operational status of the system in response to the detection of a predetermined value.

11. The detector of claim 6, wherein the predetermined value is a flow rate.

12. The detector of claim 6, wherein the predetermined value is a rate of change in the flow rate.

13. The detector of claim 6, wherein the predetermined value is based on a rate of change in the flow rate.

14. The detector of claim 1 further comprising:
a second flow detector, the results of the second flow detector allowing the locating of the occlusion.

15. A system to produce integrated circuit structures on semiconductor wafers, the system comprising:
a chamber for placing the semiconductor wafers;
a gas source, environmentally coupled to the chamber through a gaseous flow path;
a flow detector, interposed in the gaseous flow path, that determines a volume of gas flowing from the gas supply; and
a flow comparator, communicatively coupled to the flow detector, that compares the measured flow of the gas to a baseline flow of gas, a decrease in the flow of gas indicative of a blockage in the gaseous flow path.

16. The system of claim 15 wherein the flow detector is a heating element coupled to a power supply, the heating element heating the gas flowing past it.

17. The system of claim 16 further comprising:
a temperature measuring device, communicatively coupled to the heating element; and
the heating element is enabled in response to a signal from the temperature-measuring device.

18. The system of claim 16 further comprising:
a power measurement device, coupled to the heating element that measures the amount of power directed to the heating element.

19. The system of claim 15, further comprising:
a flow controller, communicatively coupled to the gas supply, that controls the flow of gas to the chamber; and
the flow controller changing the flow of the gas supply to the chamber in response to a signal from the flow detector.

20. The system of claim 15, further comprising:
control circuitry communicatively coupled to the flow detector, the control circuitry responsive to a predetermined value related to the rate of flow of the gas to the chamber.

21. The system of claim 20, wherein the control circuitry is programmable.

22. The system of claim 20, the control circuitry issuing an alarm in response to the detection of a predetermined value.

23. The system of claim 20, the control circuitry updating a maintenance schedule in response to the detection of a predetermined value.

24. The system of claim 20, the control circuitry changing the operational status of the system in response to the detection of a predetermined value.

25. The system of claim 20, wherein the predetermined value is a flow rate.

26. The system of claim 20, wherein the predetermined value is a rate of change in the flow rate.

27. The system of claim 20, wherein the predetermined value is based on a rate of change in the flow rate.

28. The system of claim 15 further comprising:
a second flow detector, the results of the second flow detector allowing the locating of the occlusion.

29. A method of detecting residue buildup in an apparatus for manufacturing integrated circuit structures on a semiconductor wafer, the apparatus comprising a chamber for placing the semiconductor wafers, the method comprising:
causing to flow through the apparatus a gas;
determining a volume of gas flowing from the gas supply; and
comparing the flow of the gas to a baseline flow of gas, wherein a decrease in the flow of gas is indicative of a blockage in the gaseous flow path.

30. The method of claim 29, the step of determining comprising:
heating the gas with an element coupled to a power supply; and
measuring the power consumed by the element.

31. The method of claim 30, the step of determining further comprising:
measuring a temperature of the gas; and
selectively enabling the element enabled in response to step of the measuring the temperature.

32. The method of claim 29, further comprising the step of:
changing the flow of the gas supply to the chamber in response to a signal from the flow detector.

33. The method of claim 29, further comprising the step of:
detecting a predetermined value; and
selectively initiating an action in response to the step of detecting.

34. The method of claim 33, the step of selectively initiating comprising the step of:
issuing an alarm in response to the detection of a predetermined value based on the step of determining a volume of gas.

35. The method of claim 33, the step of selectively initiating comprising the step of:
updating a maintenance schedule in response to the detection of a predetermined value in the step of determining or in the step of comparing.

36. The method of claim 33, the step of selectively initiating comprising:
changing the operational status of the apparatus in response to the detection of the predetermined value.

37. The method of claim 33, wherein the predetermined value is a flow rate.

38. The method of claim 33, wherein the predetermined value is a rate of change in the flow rate.

39. The method of claim 33, wherein the predetermined value is based on a rate of change in the flow rate.

40. The method of claim 29 further comprising a second flow detector, the results of the second flow detector allowing the locating of the occlusion.

41. A blockage detector for a system that produces integrated circuit structures on semiconductor wafers, the system having a chamber for placing the semiconductor wafers, the chamber environmentally coupled to a gas source through a gaseous flow path, the detector comprising:
a heating element, interposed in the gaseous flow path and coupled to a power supply, the heating element heating the gas flowing past it;
a temperature-measuring device, communicatively coupled to the heating element, that measures the temperature of the heated gas;
a power measurement device, coupled to the heating element, that measures the amount of power directed to the heating element; and
a flow detection circuitry that determines the flow of the gas past the heating element based on the power consumed by the heating element; and
a flow comparator, communicatively coupled to the flow detection circuitry that compares the measured flow of the gas to a baseline flow of gas.

42. The detector of claim 41, further comprising control circuitry communicatively coupled to the flow detection circuitry, the control circuitry responsive to a predetermined value related to the rate of flow of the gas to the chamber.

43. The detector of claim 42, wherein the control circuitry is programmable.

44. The detector of claim 42, the control circuitry issuing an alarm in response to the detection of a predetermined value.

45. The detector of claim 42, the control circuitry updating a maintenance schedule in response to the detection of a predetermined value.

46. The detector of claim 42, the control circuitry changing the operational status of the system in response to the detection of a predetermined value.

47. The detector of claim 42, wherein the predetermined value is a flow rate.

48. The detector of claim 42, wherein the predetermined value is a rate of change in the flow rate.

49. The detector of claim 42, wherein the predetermined value is based on a rate of change in the flow rate.

50. The detector of claim 41 further comprising a second flow detector, the results of the second flow detector allowing the locating of the occlusion.
